(19) United States
(12) Patent Application Publication
(10) Pub. No.: US 2026/0197582 A1
(43) Pub. Date: Jul. 9, 2026

(54) LOUDSPEAKER LEAKAGE SILENCER

(71) Applicant: Intel Corporation, Santa Clara, CA (US)

(72) Inventor: Adam Kupryjanow, Gdansk (PL)

(73) Assignee: Intel Corporation, Santa Clara, CA (US)

(21) Appl. No.: 19/556,444

(22) Filed: Mar. 4, 2026

Related U.S. Application Data
(60) Provisional application No. 63/944,019, filed on Dec. 18, 2025.

(51) Int. Cl. H04R 3/02

(52) U.S. Cl. CPC H04R 3/02

(57) ABSTRACT

Systems and methods are provided for reducing loudspeaker-to-microphone leakage in audio-enabled computing platforms. The invention provides a neural network-based Loudspeaker Leakage Silencer (LLS) module, integrated within an audio processing pipeline, that processes both microphone and loopback (reference) signals to suppress non-linear echo components resulting from device playback. The LLS module uses a light RNN-Mixer architecture configured to generate an attenuation mask, which is applied to the microphone features to achieve at least a 9 dB reduction in loudspeaker leakage. The system supports both standalone operation, wherein the LLS processes raw microphone streams, and cascade operation, wherein the LLS operates in conjunction with traditional acoustic echo cancellation (AEC) modules. The neural network model is trained using augmented audio data to ensure robust performance under diverse operating conditions. The techniques provide significant improvements in audio quality, enabling superior voice communication experiences and enhanced echo suppression capabilities for computing devices.

### CROSS-REFERENCE TO RELATED APPLICATIONS

This application is related to and claims the benefit of priority under 35 U.S.C. § 119(e) to U.S. Provisional Application No. 63/944,019, titled “Loudspeaker Leakage Silencer”, filed on Dec. 18, 2025, which is hereby incorporated by reference in its entirety.

### TECHNICAL FIELD

This disclosure relates generally to loudspeaker leakage, and in particular, to reducing loudspeaker leakage.

### BACKGROUND

Microphone-to-loudspeaker leakage refers to the phenomenon where audio played through a device's loudspeakers is inadvertently picked up by its microphones. The leakage is especially problematic during voice calls or audio capture scenarios, as it can create unwanted echoes, degrade speech quality, and disrupt natural conversation flow. The leakage occurs because the physical proximity and acoustic coupling between microphones and loudspeakers allow sound from the speakers to be re-captured by the microphones. Some solutions to decrease leakage include hardware design improvements (such as increasing the distance between components) and software-based acoustic echo cancellation (AEC) algorithms.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIGS. 1A-1B present block diagrams illustrating a simplified preprocessing capture pipeline designed to operate during device playback scenarios, in accordance with various embodiments.

FIG. 2 is a block diagram illustrating an example enhanced pipeline architecture including a loudspeaker leakage silencer, in accordance with various embodiments.

FIG. 3 is a block diagram illustrating an example LRM for use with a loudspeaker leakage silencer, in accordance with various embodiments.

FIG. 4 is a block diagram illustrating an acoustic echo generation process during a voice call, in accordance with various embodiments.

FIG. 5 is a flow chart illustrating a method for a loudspeaker leakage silencer, in accordance with various embodiments.

FIG. 6 is a block diagram of an example deep learning system, in accordance with various embodiments.

FIG. 7 is a block diagram of an example computing device, in accordance with various embodiments.

### DESCRIPTION

### Overview

Systems and methods are provided for a loudspeaker leakage silencer that includes a neural network model to significantly reduce microphone-to-loudspeaker leakage on audio-enabled computing platforms. The loudspeaker leakage silencer can be used as an extension to an audio signal enhancement system that attenuates platform fan noise and other platform self-noise, including as part of a unified self-noise silencing pipeline. In various implementations, the loudspeaker leakage silencer can be integrated into a device's audio processing pipeline.

According to various implementations, the systems and methods provided herein address the persistent technical challenge of microphone-to-loudspeaker leakage in audio-enabled computing platforms, particularly in scenarios where simultaneous audio capture and playback occur. In conventional systems, audio signals emitted by device loudspeakers are often inadvertently captured by onboard microphones, resulting in acoustic echo and degraded speech quality during voice communication sessions. Some solutions to this problem include hardware-based approaches, such as increasing the physical separation between microphones and loudspeakers or employing low-distortion speaker components, as well as software-based acoustic echo cancellation (AEC) algorithms. However, these methods are limited by trade-offs between power consumption, processing quality, and their effectiveness in suppressing non-linear echo artifacts, especially under the constraints of modern, power-efficient computing platforms.

To address microphone-to-loudspeaker leakage, a loudspeaker leakage silencer is provided herein. The loudspeaker leakage silencer is a neural network-based module, which is specifically designed for integration within an audio processing pipeline. The loudspeaker leakage silencer module extends the capabilities of platform self-noise silencing technology by introducing a lightweight, low-memory, and low-compute neural network model that operates as a front-end stage in conjunction with a self-noise silencer component (e.g., SNS/PSNS). The loudspeaker leakage silencer model is configured to process both the microphone signal and a loopback reference signal representing the audio content played through the device's loudspeakers. In some examples, the loopback reference signal can include two channels corresponding to a two-loudspeaker device configuration. In some examples, by leveraging a modified light recurrent neural network (RNN)-Mixer architecture, the loudspeaker leakage silencer model is trained to selectively suppress non-linear components of the acoustic echo, achieving a reduction in loudspeaker leakage. The loudspeaker leakage silencer model can be adjusted to reduce loudspeaker leakage by any selected level (e.g., from 0 dB to any amount greater than 0 dB). In one example, the loudspeaker leakage silencer model reduces loudspeaker leakage by around 9 dB. Additionally, the loudspeaker leakage silencer model avoids aggressive processing by retaining a controlled amount of linear echo for subsequent linear AEC stages.

According to various implementations, the integration of the loudspeaker leakage silencer module within the audio processing pipeline enables two principal modes of operation. In standalone mode, the loudspeaker leakage silencer processes raw microphone streams to attenuate echo prior to any AEC processing, thereby improving the baseline audio quality. In cascade mode, the loudspeaker leakage silencer operates in tandem with traditional AEC modules executed in software and/or firmware, further reducing residual echo levels that remain after linear echo cancellation. This dual-mode capability ensures consistent enhancement of audio capture quality across a range of device configurations and use cases, including voice communication pipelines where linear AEC and post-filter processing are present.

In some implementations, the architecture of the loudspeaker leakage silencer can be modified to accommodate dual-input processing, including the expansion of the model's input feature space to support interleaved microphone and loopback channels, and the generation of an output mask applied to the microphone features. The training methodology can incorporate advanced signal augmentation techniques, such as sample rate simulation, silence simulation, delay variation, and dynamic range adjustment, to ensure robust model performance under diverse real-world conditions. In some implementations, training data are generated by simulation using impulse responses and a loopback reference, and can be further augmented by downsampling/upsampling a portion of far-end samples to emulate voice-call bandwidth limitations, adding a randomized delay between microphone and loopback streams, and varying gains applied to microphone and loopback streams to reflect observed level ranges on device-under-test platforms. Objective quality assessment conducted using industry-standard metrics, including Weighted Terminal Coupling Loss and Mean Opinion Score, yielded experimental results demonstrating substantial improvements in echo suppression and perceived audio quality relative to legacy configurations.

According to various implementations, the systems and methods provided herein allow non-linear echo suppression to be performed at an earlier stage than conventional approaches. In particular, whereas non-linear echo reduction is commonly addressed by a post-filter stage operating after linear AEC, the systems and methods herein enable a neural-network-based reduction of non-linear loudspeaker distortion components prior to linear echo cancellation, thereby simplifying subsequent echo cancellation processing and improving overall pipeline effectiveness.

Thus, the systems and methods discussed herein provide a significant advancement in the field of audio signal processing for computing platforms by delivering an efficient, neural network-based solution to the problem of microphone-to-loudspeaker leakage. The loudspeaker leakage silencer module enhances the effectiveness of existing noise and echo suppression technologies, thereby enabling superior voice communication experiences and improved audio processing capabilities for end users.

For purposes of explanation, specific numbers, materials, and configurations are set forth in order to provide a thorough understanding of the illustrative implementations. However, it will be apparent to one skilled in the art that the present disclosure may be practiced without the specific details or and/or that the present disclosure may be practiced with only some of the described aspects. In other instances, well-known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order-dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but
these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods, and devices of this disclosure each have several innovative aspects, no single one of which is solely responsible for all desirable attributes disclosed herein. Details of one or more implementations of the subject matter described in this specification are set forth in the description below and the accompanying drawings.

### Example Preprocessing Capture Pipelines

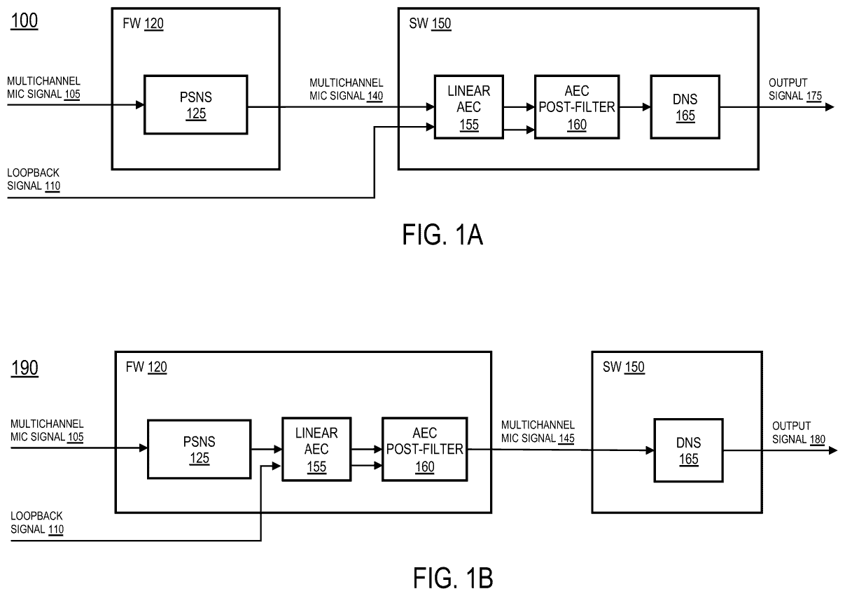

FIGS. 1A-1B present block diagrams illustrating simplified preprocessing capture pipelines 100, 190 designed to operate during device playback scenarios, in accordance with various embodiments. FIG. 1A is an Audio Processing Object (APO)-based software pipeline. FIG. 1B is an acoustic echo cancellation (AEC) processing pipeline, in which the AEC post-filter 160 is implemented in firmware 120. According to various examples, in both FIGS. 1A and 1i, the microphone preprocessing pipeline employs a two-stage AEC approach. The first stage includes a linear AEC module, which is a standardized algorithm providing approximately 20 dB of echo attenuation and is implemented with relative consistency across independent software vendors. The second stage is a non-linear echo cancellation module, also referred to as the AEC post-filter, which serves as the differentiating component that may define the capabilities of each independent software vendor. The post-filter enables an additional 10 to 40 dB of echo cancellation beyond what is achieved in the linear stage.

In FIG. 1A, a preprocessing capture pipeline 100 receives a multichannel microphone signal 105 and, in firmware block 120, the multichannel microphone signal 105 is processed at a platform self-noise silencer 125 to attenuate platform self-noise and provide an enhanced microphone stream 140. The resulting enhanced multichannel microphone signal 140 is provided to a software block 150, which applies a two-stage acoustic echo cancellation path including a linear AEC module 155 and an AEC post-filter module 160. The loopback signal 110 is provided to the linear AEC module 155 as a reference stream for echo-related processing. The software block 150 further includes a dynamic noise suppression (DNS) module 165 to suppress residual noise components. The output of the DNS module 165 (and of the software block 150) is a processed multichannel microphone output signal 175. In various examples, the processed multichannel microphone output signal 175 can be used for downstream voice communication or other audio capture use cases.

In FIG. 1B, a preprocessing capture pipeline 190 receives a multichannel microphone signal 105 and, in firmware block 120, the multichannel microphone signal 105 is processed at a platform self-noise silencer 125. In particular, a platform self-noise silencer 125 performs front-end microphone preprocessing, and, in the firmware block 120, the preprocessed signal is then provided to a two-stage echo control path including a linear AEC module 155 and an AEC post-filter module 160. A loopback signal 110 is provided as a reference signal at the linear AEC module 155 and the AEC post-filter module 160 for echo-related processing in the firmware block 120. The resulting multichannel microphone signal 145 is then provided to software block 150, in which a DNS module 165 performs additional noise suppression to generate a processed multichannel microphone output signal 180. In various examples, the processed multichannel microphone output signal 180 can be used for downstream voice communication or other audio capture use cases.

In some implementations, systems and methods are provided for integrating a loudspeaker leakage silencer with a platform self-noise silencer, such as the platform self-noise silencer 125 of FIGS. 1A and 1B. A platform self-noise silencer can be a lightweight neural network-based module integrated within the AEC firmware. A platform self-noise silencer effectively removes platform-generated self-noise captured by internal computing device microphones, resulting in measurable audio quality improvements. Microphone SNR (Signal-to-Noise Ratio) and SDNR (Signal-to-Distortion Ratio) can be enhanced by at least 6-9 dB on various platforms with a platform self-noise silencer. However, Acoustic Echo Canceller (AEC) implementations face significant limitations in device playback scenarios. As shown in FIGS. 1A and 1i, AEC algorithms are executed either as software components within software (e.g., within an Audio Processing Object) or as firmware components within firmware (e.g., AEC firmware).

According to some examples, software-based AEC execution, as shown in FIG. 1A, can significantly increase platform power consumption due to its software-based nature. In contrast, the firmware-based AEC implementation, as shown in FIG. 1B, is constrained by limited memory and computing resources, which prevents the execution of algorithms with the same quality as those achievable in software implementations. This dichotomy creates a fundamental tradeoff for independent software vendors between power consumption and processing quality during AEC implementation. Thus, in some examples, FIGS. 1A and 1B highlight the architectural and operational differences between software-based and firmware-based AEC solutions, as well as the inherent limitations and tradeoffs associated with each approach in the context of device playback and audio signal processing.

### Example Loudspeaker Leakage Silencer System

Systems and methods are presented for a loudspeaker leakage silencer system that includes a neural network model architecture that is both memory and compute efficient. In particular, a new component is provided for adding to a Platform Self-Noise Silencer (PSNS) module, designated as the Loudspeaker Leakage Silencer (LLS). To ensure architectural consistency and maintain PSNS as a unified pipeline module, the LLS can be seamlessly integrated with a Self-Noise Silencer (SNS).

According to various implementations, systems and methods are presented for a platform self-noise suppression system that includes a causal model architecture that is both memory and compute efficient. The model can include a recurrent neural network (RNN). A RNN is a type of artificial neural network that can be used to process sequential data such as audio signals. In some embodiments, the platform self-noise suppression system can be implemented as a regular RNN-Mixer (RRM), and in some embodiments, the platform self-noise suppression system can be implemented as a light RNN-Mixer (LRM). In some embodiments, the RRM features a custom Gated Recurrent Unit (GRU) layer. The LRM is a streamlined version of the RRM that can be implemented using various machine learning frameworks. In some examples, the LRM's simplicity makes it more accessible for practical applications than the RRM.

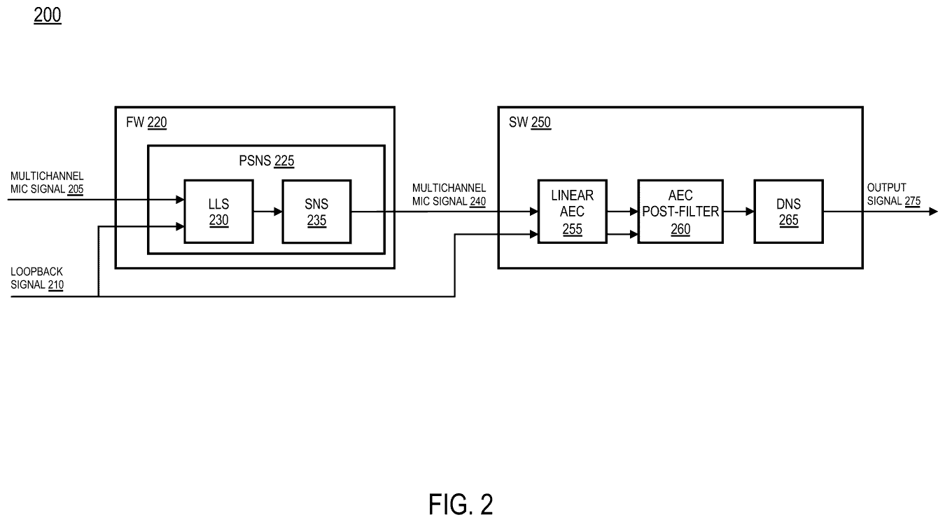

FIG. 2 is a block diagram illustrating an example enhanced pipeline architecture 200 including a loudspeaker leakage silencer 230, in accordance with various embodiments. In particular, FIG. 2 shows an example of a LLS 230 within an overall audio preprocessing framework including a firmware block 220 and a software block 250. In various examples, the enhanced pipeline architecture 200 can use a loopback signal 210 as a reference stream to preprocess a multichannel microphone signal 205 using a platform self-noise silencing block 225 and echo-reduction in the software block 250. The enhanced pipeline architecture 200 can output a processed output signal 275 for device-playback and voice-communication scenarios.

In various implementations, the firmware block 220 includes a platform self-noise silencing module 225 that receives the multichannel microphone signal 205 and a loopback signal 210. The platform self-noise silencing module 225 includes a LLS 230 and a self-noise silencer (SNS) 235. The SNS 235 applies platform self-noise mitigation to attenuate platform-generated noise. The LLS 230 reduces loudspeaker leakage. Unlike conventional acoustic echo cancellation stages that operate later in the processing pipeline, the LLS 230 operates early, within firmware, and specifically targets non-linear echo components before linear AEC and post filter stages are applied. In particular, in conventional audio processing pipelines, non linear echo components are typically addressed only at a post filter stage following linear acoustic echo cancellation. In contrast, the systems and methods provided herein deliberately perform partial non-linear loudspeaker leakage suppression at an earlier stage, prior to linear acoustic echo cancellation, thereby improving downstream processing while maintaining double talk robustness.

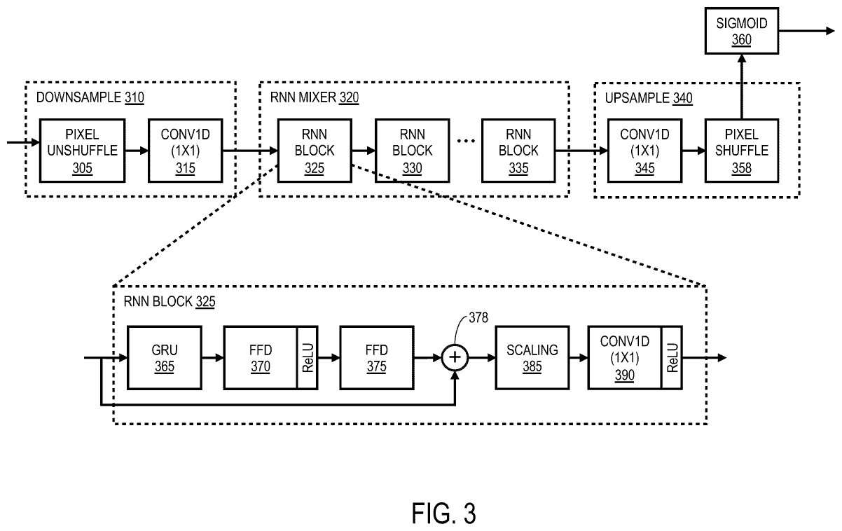

In various implementations, the LLS 230 is implemented as a neural network model that processes two distinct input streams: a multichannel microphone signal 205 and a loopback signal 210. The microphone signal 205 represents the audio captured by the device's internal microphones, and the loopback signal 210 includes the audio content actively played through the device's loudspeakers. The loopback signal 210 is also referred to as the reference stream. At the LLS 230, a neural network processes the multichannel microphone signal 205 and the loopback signal 210 to reduce loudspeaker leakage. In various examples, the model is specifically trained to focus on removing non-linear components of acoustic echo. Thus, in various examples, the LLS 230 reduces loudspeaker leakage of non-linear echo components. An example of a neural network for loudspeaker leakage silencing is described with respect to FIG. 3.

The output of the LLS 230 is provided to the SNS 235. In various examples, the SNS 235 performs additional self-noise silencing on the microphone stream processed by the LLS 230 to further attenuate platform self-noise components. The output from the SNS 235 is an enhanced multichannel microphone signal 240.

The enhanced multichannel microphone signal 240 is input to the software block 250, where two-stage acoustic echo cancellation is applied. In particular, a linear AEC 255 receives the enhanced multichannel microphone signal 240 and the loopback signal 210. The linear AEC 255 performs standardized linear echo attenuation using the two input signals. The output from the linear AEC 255 is processed at an AEC post-filter 260, which performs non-linear echo cancellation. In various examples, conditioning the microphone stream in firmware using the LLS 230 before the software AEC stages at the linear AEC 255 and the AEC post-filter 260 increases the effectiveness of the subsequent echo processing.

In the software block 250, the output of the AEC post-filter 260 is provided to a DNS block 265. At the DNS block 265, additional noise suppression is applied to generate the output signal 275. Thus, FIG. 2 illustrates an image processing pipeline in which firmware processing produces a processed microphone stream that is refined in a software block 250 using echo cancellation (at linear AEC 255 and AEC post-filter 260) and noise suppression (at DNS 265). In various implementations, one or more of the operations performed at the software block 250 can be performed in firmware, as described, for example, with respect to FIG. 1B.

According to various implementations, for loudspeaker leakage silencing, the training target is defined to preferentially remove non-linear echo while retaining a controlled portion of linear echo for subsequent treatment by a conventional linear AEC. In particular, the target preserves linear echo at a specified attenuation (e.g., about 9 dB) and excludes non-linear distortion terms, causing the LRM to learn a microphone-only mask that suppresses far-end playback leakage. In various implementations, the loudspeaker leakage silencer is intentionally configured to suppress only a highest energy portion of non-linear echo components, rather than fully eliminating such components, in order to avoid over-attenuation of near-end speech during double talk conditions and to preserve stable operation and effectiveness of downstream acoustic echo cancellation stages. Thus, in some examples, the loudspeaker leakage silencer is designed to include a this design tradeoff motivated by robustness and user experience.

According to various implementations, an LLS, such as the LLS 230, can have an architecture based on a light RNN-Mixer (LRM). FIG. 3 is a block diagram illustrating an example LRM for use with a loudspeaker leakage silencer, in accordance with various embodiments. The light RNN-Mixer architecture of FIG. 3, implemented for an LLS, provides an efficient, unified pipeline that interleaves a multichannel microphone signal and stereo loopback features, estimates a microphone-specific attenuation mask via recurrent and convolutional processing, restores feature shape through upsampling and pixel shuffling, and outputs a normalized mask that materially reduces loudspeaker leakage at low computational cost.

In some examples, FIG. 3 provides a detailed schematic of the LRM architecture, highlighting the neural network's internal structure, data flow, and feature transformation mechanisms. To enable the model to process loopback streams in addition to microphone input, the model includes extended input processing, output mask generation, and optimized hyperparameters.

The LRM of FIG. 3 includes three primary components: a downsample module 310, a RNN-Mixer 320, and an upsample block 340. During the downsampling phase, the number of channels is increased while the tensor height is reduced. The downsample module 310 includes a pixel unshuffle module 305 and a 1D pointwise convolution block 315. At the pixel unshuffle module 305, the input undergoes a pixel unshuffle operation. In some examples, the pixel unshuffle module 305 rearranges elements between channels and tensor height. In some examples, the pixel unshuffle module 305 alters the tensor's width. In various examples, the pixel unshuffle operation takes a tensor of shape (*, C, H×r, W) and outputs a tensor of shape (*, C×r, H, W), where r represents the downsampling factor. The output from the pixel unshuffle module 305 undergoes a pointwise convolution at the 1D pointwise convolution block 315. In particular, in various examples, a 1D pointwise convolution is applied to group features into subgroups, each subgroup containing similar information. Features can include frequencies, frequency bands, amplitudes, and other audio signal information. In some examples, subgroups include similar features that are in neighboring channels in feature space. For instance, information stored in neighboring channels can have similar frequency bands and similar amplitudes, and subgroups can include channels having similar features such as similar frequencies, similar frequency bands, similar amplitudes, and so on. Features having similar information can be grouped in a subgroup and treated as one group of values that is processed using the same weights and biases. In some examples, a subgroup can be treated as one input channel to the convolution layer. The 1D pointwise convolution can have a kernel size of one. In the LLS configuration, the downsample module 310 receives interleaved features derived from the microphone stream together with two loopback/reference streams (e.g., stereo loudspeaker channels), and produces a compact representation suitable for leakage suppression while preserving the microphone feature dimensionality for later masking.

The output from the downsample module 310 is input to the RNN mixer 320, which can include a sequence of recurrent processing blocks within the RNN mixer 320. The RNN mixer 320 estimates an attenuation mask from the compact features, optionally leveraging temporal context from preceding frames to track echo dynamics and to suppress non-linear loudspeaker leakage components associated with the far-end playback.

The RNN mixer 320 includes multiple RNN blocks 325, 330, 335, with the output from one RNN block being input to a subsequent RNN block. In particular, the RNN mixer 320 includes an RNN block repeated D times. In some embodiments, the RNN mixer 320 can include any number of RNN blocks, such as two RNN blocks, three RNN blocks, four RNN blocks, five RNN blocks, or more than five RNN blocks. Each RNN block 325, 330, 335 can include the elements shown in the blown-up view of the RNN block 325. In particular, the RNN block 325 includes a GRU layer 365, a first feed-forward layer 370, which includes a ReLU (rectified linear unit), a second feed-forward layer 375, an adder 378, a 3×1 1D convolution layer 380, which includes another ReLU, a scaling layer 385, and a 1×1 1D convolution layer 390. In the LLS LRM, these blocks can cooperate to learn leakage-specific features: the GRU layer captures frame-to-frame dependencies of the echo path; the feed-forward layers and 1D convolutions refine spectral-temporal patterns associated with non-linear loudspeaker distortions; the scaling layer normalizes the mask intensity to stabilize downstream application.

The input to the RNN block 325 is received at the GRU 365 and also received at the adder 378. The GRU 365 can be a custom GRU, and performs a gating function, as described in greater detail below. The custom GRU 365 is designed to allow for a reduction in the number of model parameters. The output from the GRU 365 is input to the feed-forward layer 370 with the ReLU, and the output from the feed-forward layer 370 is input to the feed-forward layer 375.

The output from the feed-forward layer 375 is added to the input to the RNN block 325 at the adder 378. The output from the adder 378 is processed by the 3×1 1D convolution layer 380, which includes another ReLU. The output from the 3×1 1D convolution layer 380 is scaled at the scaling layer 385, and then processed by the 1×1 1D convolution layer 390. The output from the RNN block 325 has a reduced loudspeaker leakage compared to the input to the RNN block 325. The output from the RNN block 325 can be input to a subsequent RNN block 330. In various examples, the RNN block 330 can include the same components as the RNN block 325.

The output from the RNN mixer 320 is input to the upsample block 340. The upsample block 340 includes a 1×1 1D convolution layer 345, a 3×1 1D convolution layer 355, and a pixel shuffle block 358. The upsample block 340 performs an upsampling step to restore the original feature shape. In particular, the 1×1 1D convolution layer 345 performs a 1D pointwise convolution, and the 3×1 1D convolution layer 355 performs a 1D convolution using a kernel size of three. The pixel shuffle block 358 rearranges its input from a tensor of shape (*, C×r, H, W) back into a tensor of shape (*, C, H×r, W). In various embodiments, the output from the upsample block 340 is an output mask that represents a probability of useful signal presence in feature space. The output mask can be processed at a sigmoid block 360 to generate the output mask for the LRM 300 in FIG. 3. In various examples, the sigmoid block 360 smooths the output mask. In some implementations, for a LLS, the resulting mask is applied to the microphone feature stream, leaving the loopback/reference features untouched, thereby preserving microphone feature dimensionality while suppressing echo components.

In the LLS implementation shown in FIG. 3, the LRM retains the GRU-based recurrent processing and both the 3×1 and 1×1 convolutional refinements depicted, ensuring low-compute operation while maintaining suppression efficacy for non-linear echo. While a parameter-efficient GRU variant may be used, the LLS LRM can also operate with a standard GRU configuration. In both the parameter-efficient GRU variant and the standard GRU configuration, gating dynamics capture the temporal evolution of the loudspeaker-to-microphone leakage path. Hyper-parameter selection for loudspeaker leakage silencing can follow a mRLM profile in which S represents the input stream count, Nᵢₙ, represents the input features count, Nₒᵤₜ represents the output features count, r represents the number of features per stream, F represents the features count, and D represents the depth. In some examples, the mRLM profile can include S=3 interleaved streams (including one microphone and two loopback channels), Nᵢₙ=2304, Nₒᵤₜ=768, D=6, providing a low-memory, low-compute footprint consistent with audio firmware constraints.

According to various implementations, the model input can include an interleaved configuration combining microphone features from a microphone feature stream with two channels of loopback features (Nᵢₙ=2304). The input expansion allows the model to simultaneously analyze the microphone signal and both loopback channels, which correspond to a computing device configuration including two loudspeakers. In some examples, the interleaved input structure ensures that the model can effectively capture and suppress leakage across multiple audio pathways.

In some examples, to implement output mask generation, the model generates an output mask including three times fewer values than the input (Nₒᵤₜ=768). The output mask can be applied to the microphone features. In some examples, the output mask can be applied exclusively to the microphone features, thereby preserving the original microphone feature dimensionality and ensuring that the processed output remains compatible with existing audio processing modules. The selective masking mechanism allows for precise attenuation of leakage components without distorting the speech signal.

In some examples, to implement optimized hyperparameters, the LLS model hyperparameters can be systematically adjusted from those used in a platform self-noise silencer to accommodate the extended input processing requirements. The optimizations can include modifications to the number of input streams, feature counts, and model depth. An example of hyperparameter values is detailed in Table 1 below. In particular, Table 1 shows a comparison of hyperparameters for a platform self-noise silencer light RNN-Mixer (RLM) and a modified light RNN-Mixer for the loudspeaker leakage silencer model (mRLM). In some examples, the revised hyperparameters for the LLS are used to maintain computational efficiency and ensure robust performance across a wide range of device configurations and operational scenarios.

TABLE 1

| Hyper-parameter | RLM | mRLM |
|---|---|---|
| S | 1 | 3 |
| Nᵢₙ | 768 | 2304 |
| Nₒᵤₜ | 768 | 768 |
| r | 32 | 32 |
| F | 8 | 32 |
| D | 6 | 6 |

where S represents the input stream count, Nᵢₙ represents the input features count, Nₒᵤₜ represents the output features count, r represents the number of features per stream, F represents the features count, and D represents the depth.

According to various examples, the LLS module described herein, for example the LLS 230, is designed to deliver improved performance (i.e., lower loudspeaker leakage) in both standalone operation and in cascade operation. In standalone operation, raw microphone streams are processed without subsequent acoustic echo cancellation (AEC), and the echo level in the captured audio is significantly reduced, resulting in a cleaner signal for downstream processing. In cascade operation, the LLS functions in conjunction with traditional AEC processing modules, attenuating loudspeaker leakage that otherwise persists after linear echo cancellation. The overall loudspeaker leakage level achieved through the combined approach is significantly lower than what is attainable with conventional preprocessing pipelines. The consistently lowered loudspeaker leakage results across diverse implementation scenarios ensure that including a loudspeaker leakage silencer in processing firmware as provided herein significantly enhances audio quality regardless of the specific configuration or sequence of subsequent processing stages.

### Example Signal Augmentation for a Loudspeaker Leakage Silencer

In various implementations, during training, the model input and corresponding target signals are generated using two audio samples: a near-end source signal S_{NE}, representing a signal source located in a near-end environment, and a far-end source signal S_{FE}, representing a signal source located at a remote environment. The simulated microphone signal X, which models microphone capture during device playback, is generated using Equation (1) below. The simulated microphone signal X includes both linear echo components and non-linear echo components attributable to loudspeaker distortion. The corresponding loopback (reference) signal R is obtained using Equation (2) below.

$$X = {IR}_{1} * {S}_{NE} + {IR}_{2} * {S}_{FE} + {IR}_{2} * NL \qquad ( 1 )$$

$$R = {IR}_{2} * {S}_{FE} \qquad ( 2 )$$

In these equations, IR₁ represents the impulse response of the near-end room and a first device under test (DUT1), IR₂ represents the impulse response of the far-end room and a second device under test (DUT2), and NL represents non-linear distortion components introduced by the loudspeakers of the DUT1.

The simulation process may be performed using a laboratory simulation tool. In some examples, to increase variability of a training dataset and to adapt signal characteristics to an input format of a loudspeaker leakage silencer (LLS) model, both near-end and far-end source signals undergo signal processing prior to (pre-mix) and subsequent to (post-mix) a laboratory simulation step.

In various examples, pre-mix processing includes sample rate simulation, signal length normalization, and silence simulation. During sample rate simulation, to emulate voice communication scenarios operating at reduced bandwidth, approximately 40-60% of S_{FE} samples are downsampled from 48 kHz to 16 kHz and then upsampled back to 48 kHz, thereby attenuating frequency content above 8 kHz in S_{FE} while maintaining full bandwidth (approximately 24 kHz) content for S_{NE}. During signal length normalization, both S_{NE} and S_{FE} are trimmed or extended to a uniform duration of approximately four seconds for LLS training, with shorter signals repeated as needed. Silence simulation is performed by selectively zeroing portions of S_{NE} and/or S_{FE} to represent inactive near-end or far-end scenarios.

In various examples, post-mix processing includes delay variation simulation, channel configuration standardization, dynamic range simulation, and anti-aliasing filter alignment. During delay variation simulation, to account for device-dependent timing offsets between microphone and loopback streams, a random delay between approximately 0 and 50 milliseconds is introduced between the simulated microphone signal X and the loopback signal R, with the microphone signal maintained temporally ahead of the loopback signal. During channel configuration standardization, to maintain a consistent model input format comprising one microphone channel and two loopback channels, when S_{FE} includes a single channel, a second loopback channel is generated by duplicating the first channel to form a double mono configuration. During dynamic range simulation, signal levels of X and R are randomly adjusted to reflect observed playback variability, with X gains selected from approximately −65 dB to −3 dB and R gains selected from approximately −45 dB to 0 dB. During anti-aliasing filter alignment, frequency components above approximately 22.75 kHz are attenuated, and mask values for these frequencies are derived by propagating a mask value associated with the highest non-attenuated frequency bin. In some examples, frequency components above approximately 22.75 kHz are zeroed. In some examples, after mask estimation by the LLS model, mask values for the high-frequency bins are generated by copying a mask value from the last frequency bin before the zeroed range.

According to various examples, a model target signal S_{T} is defined using Equation (3). A parameter controls an amount of linear echo retained in the target signal, while a parameter ε corresponds to a level of non-linear distortion. In some examples, is configured to reduce linear echo by approximately 9 dB and ε is set to zero, thereby biasing model training toward suppression of non-linear distortion while preserving residual linear echo for subsequent processing by a linear acoustic echo canceller.

$${S}_{T} = {IR}_{1} * {S}_{N E} + μ \cdot ( {IR}_{2} * {S}_{F E} ) + ε ( {IR}_{2} * NL ) \qquad ( 3 )$$

Quality assessment of leakage reduction may be performed using Weighted Terminal Coupling Loss in Single Talk conditions (TCLw). TCLw is expressed in decibels and is calculated as a function of a magnitude spectrum S(k,w) of a near-end signal and a magnitude spectrum M(k,w) of a microphone captured signal at a device under test. Lower TCLw values correspond to improved echo attenuation.

$$TCLw = 20 {log}_{10} \frac{S ( k , w )}{M ( k , w )} \qquad ( 4 )$$

TCLw is expressed in dB, with lower values indicating better echo signal attenuation. TCLw measurements can be performed in single talk scenarios in which only near-end speech or device playback is active. Additional objective quality assessment may be performed using an ACOP32 evaluation framework, in which each processed signal frame is assigned to a quality category selected from {A1, A2, B, C, D, E, F, G}, with A1 indicating highest quality. Quality scores are determined for double talk (DT) scenarios, in which near-end and far-end speech are simultaneously present, and single talk (ST) scenarios, with reported metrics corresponding to a percentage of frames classified as A1 or A2. To evaluate preservation of near-end speech during double talk conditions, DT attenuation is measured by comparing near-end speech levels in ST and DT recordings containing identical near-end content. Ideal acoustic echo cancellation maintains equivalent signal levels, corresponding to approximately 0 dB DT attenuation. Subjective quality estimation may additionally be obtained using EQUEST testing, which provides mean opinion score (MOS) estimates and is performed as part of a voice communication certification framework. Such evaluations are conducted under nominal playback conditions (approximately 70 dB SPL at 0.5 meters from a device under test) and maximum playback conditions corresponding to device-specific output capability.

According to various implementations, the systems and methods provided herein are configured to support operation in multiple processing scenarios, including a first scenario without audio processing object (APO) processing corresponding to a raw platform configuration, and a second scenario including a voice communication processing configuration with APO processing enabled. In some implementations, signal scoring and processing of the systems and methods provided herein are performed using recorded audio captured from a computing device representative of a target platform. Evaluation and measurement may be performed in accordance with applicable platform qualification and voice communication certification settings.

In the raw platform configuration, evaluation of signal quality of a LLS system in the absence of APO processing as provided herein can be performed. In this configuration, a baseline mode with platform self-noise suppression (PSNS) disabled can be compared with an operational mode in which a loudspeaker leakage silencer (LLS) is enabled in combination with self-noise suppression (SNS). The results demonstrated that in a raw platform configuration without audio processing object (APO) processing, enabling LLS in combination with self-noise suppression (SNS) substantially reduces loudspeaker leakage and improves perceived audio quality, as reflected by a significant improvement in weighted terminal coupling loss (TCLw) and mean opinion score (EQUEST MOS) at both nominal and maximum playback levels, relative to a baseline configuration with PSNS disabled.

According to various examples, in a voice communication configuration including APO-based linear acoustic echo cancellation and post-filter processing, operation in a cascade mode with firmware-level LLS provides additional gains over a legacy APO only pipeline, including improved TCLw, higher objective quality classification percentages (A1/A2) in both double-talk and single-talk scenarios, and higher EQUEST MOS values at nominal and maximum playback levels.

### Example Loudspeaker Leakage Silencing During a Voice Call

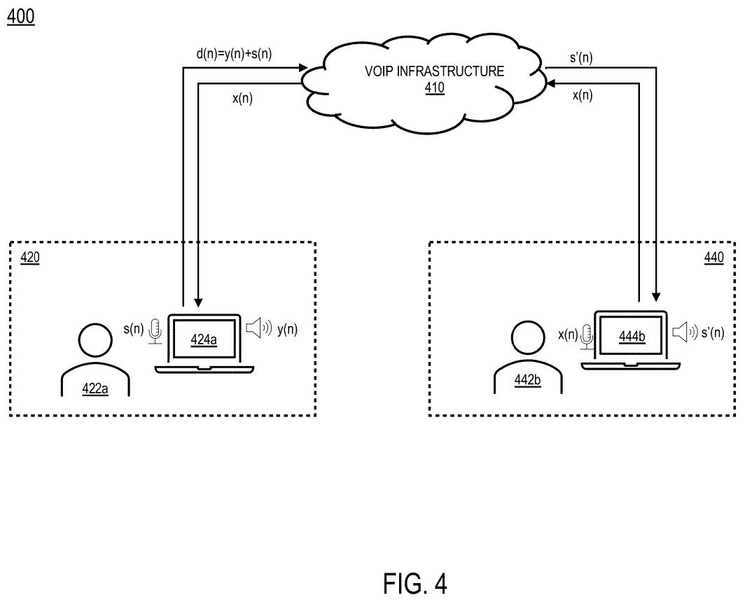

FIG. 4 is a block diagram illustrating an acoustic echo generation process during a voice call and the role of loudspeaker leakage silencing in mitigating echo artifacts, in accordance with various embodiments. In some examples, AEC algorithms are essential in scenarios where capture (microphone) and playback (loudspeaker) endpoints operate simultaneously. FIG. 4 illustrates a typical voice call scenario between two computing devices: one located in the near-end room and another in the far-end room. The acoustic echo generation process can include an echo occurring through a predictable sequence of events during voice calls. When the near-end user speaks, the microphone captures the speech source signal s(n). However, when the far-end user speaks while the near-end user remains quiet, the near-end microphone captures signal y(n), which represents speech transmitted from the far-end room. This captured signal y(n) is then transmitted via VoIP infrastructure and played through the far-end device's loudspeakers, creating an unwanted echo of the far-end user's own speech back to the far-end user.

To mitigate this echo effect, the voice call processing pipeline can include both loudspeaker leakage silencing and acoustic echo cancellation. In some embodiments, a loudspeaker leakage silencer operates on the microphone signal in conjunction with a loopback reference signal x(n) associated with loudspeaker playback to suppress non-linear loudspeaker leakage components prior to conventional echo cancellation. An acoustic echo canceller (AEC) then processes two concurrent input signals, namely the microphone signal s(n) captured by the local microphone and the loopback signal x(n) representing audio played through the local loudspeakers, to estimate and remove remaining echo components attributable to far-end speech. By reducing loudspeaker leakage, particularly non-linear distortion components, prior to or in combination with AEC processing, the systems and methods provided herein improve echo suppression performance and reduce the likelihood that the far-end user hears a reflected version of their own speech, thereby maintaining a more natural and intelligible conversational experience.

### Example Method for Loudspeaker Leakage Silencing

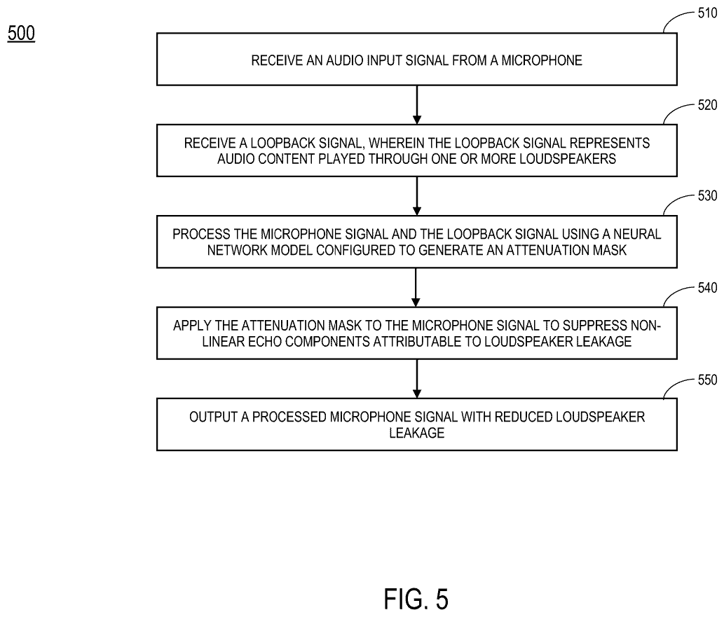

FIG. 5 is a flowchart illustrating an example method 500 for loudspeaker leakage silencing, in accordance with various embodiments. The method 500 may be performed by an audio-enabled computing platform and may be implemented in firmware, or a combination of firmware and software. In various examples, the method 500 operates on audio signals captured during device playback scenarios to suppress non-linear echo components attributable to loudspeaker leakage. The method 500 may be performed prior to downstream audio processing stages, and/or in conjunction with downstream audio processing stages.

At 510, the method 500 includes receiving an audio input signal from a microphone. The audio input signal may include near-end speech as well as acoustic components resulting from playback of audio through one or more loudspeakers of the computing platform. In some examples, the microphone signal represents a raw or preprocessed capture signal provided by a microphone array or a single microphone element.

At 520, the method 500 includes receiving a loopback signal, wherein the loopback signal represents audio content played through one or more loudspeakers. The loopback signal may correspond to a reference stream associated with device playback. In some examples, the reference stream includes one or more channels corresponding to multiple loudspeakers. The loopback signal provides information indicative of audio content that may acoustically couple into the microphone signal.

At 530, the method 500 includes processing the microphone signal and the loopback signal using a neural network model configured to generate an attenuation mask. In various embodiments, the neural network model comprises a light recurrent neural network-based architecture that jointly analyzes the microphone signal and the loopback signal to estimate spectral-temporal regions associated with loudspeaker leakage, including non-linear distortion components introduced during playback.

At 540, the method 500 includes applying the attenuation mask to the microphone signal to suppress non-linear echo components attributable to loudspeaker leakage. In some examples, the attenuation mask is applied selectively to microphone features, thereby reducing loudspeaker leakage while preserving desired near-end speech content and maintaining compatibility with downstream audio processing pipelines.

At 550, the method 500 includes outputting a processed microphone signal with reduced loudspeaker leakage. The processed microphone signal may be provided to one or more subsequent audio processing stages, including acoustic echo cancellation, noise suppression, or voice communication processing, or may be exposed as an output signal for capture or transmission.

### Example DNN System

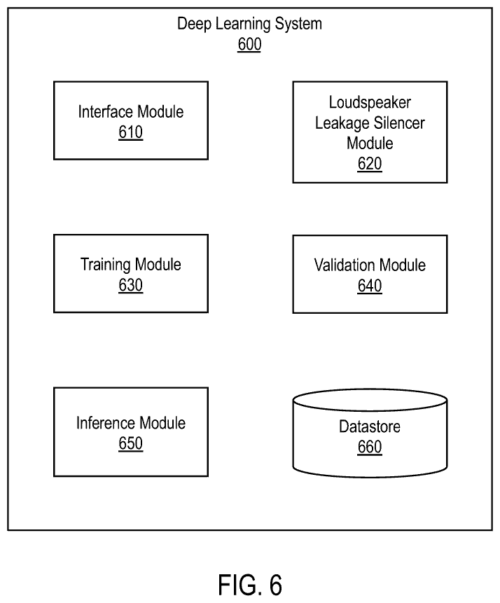

FIG. 6 is a block diagram of a deep learning system 600 that can be used for a LLS system, in accordance with various embodiments. In some embodiments, the deep learning system 600 is a deep neural network (DNN). The deep learning system 600 trains DNNs for various tasks, including, for example, noise reduction such as loudspeaker leakage silencing. In the embodiments of FIG. 6, the deep learning system 600 includes an interface module 610, a training module 630, a validation module 640, a LLS 620, and a datastore 660. In other embodiments, alternative configurations, different or additional components may be included in the deep learning system 600. Further, functionality attributed to a component of the deep learning system 600 may be accomplished by a different component included in the deep learning system 600 or a different module or system, such as any of the neural networks and/or deep learning systems described herein.

The interface module 610 facilitates communications of the deep learning system 600 with other modules or systems. For example, the interface module 610 establishes communications between the deep learning system 600 and an external database to receive data that can be used to train DNNs or input into DNNs to perform tasks. As another example, the interface module 610 supports the deep learning system 600 to distribute DNNs to other systems, e.g., computing devices configured to apply DNNs to perform tasks.

The training module 630 trains DNNs by using a training dataset. In some examples, the training dataset can be generated using synthetic audio samples. In some examples, multiple datasets can be used to provide a variety of audio source types (e.g., human speech, instruments, animals, environmental sounds, etc.). For each sample in a dataset, loudspeaker leakage noise can be added. To generate the training output, the convolution module 341 performs audio enhancement and loudspeaker leakage silencing on the audio signals.

In an embodiment where the training module 630 trains a DNN to enhance microphone SNR and SDNR and reduce loudspeaker leakage noise, and generate an output enhanced audio signal, the training dataset includes training signals including multiple sources (including the target audio signal), and training labels. The training labels describe the target sound sources in the training signals, the microphone noise, and the platform noise. The DNN operates on the combined signals to reduce noise from various sources, and the training module 630 can compare the enhanced signals generated by the DNN to the original signals. In some embodiments, a part of the training dataset may be used to initially train the DNN, and the rest of the training dataset may be held back as a validation subset used by the validation module 640 to validate the performance of a trained DNN. The portion of the training dataset not including the tuning subset and the validation subset may be used to train the DNN.

The training module 630 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as the number of hidden layers, etc. Hyperparameters also include variables that determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backward through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 3, 30, 300, 400, or even larger.

The training module 630 defines the architecture of the DNN, e.g., based on some of the hyperparameters. The architecture of the DNN includes an input layer, an output layer, and a plurality of hidden layers. The input layer of a DNN may include tensors (e.g., a multidimensional array) specifying attributes of the input signal, such as frequency, volume, and other spectral characteristics. The output layer includes labels of angles and/or locations of sound sources in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input signals to perform feature extraction. In some examples, the feature extraction is based on a spectrogram of an input sound signal. A pooling layer is used to reduce the volume of the input signal after convolution. It is used between two convolutional layers. A fully connected layer involves weights, biases, and neurons. It connects neurons in one layer to neurons in another layer. It is used to classify signals between different categories by training. Note that training a DNN is different from using the DNN in real-time and when using a DNN to process data that is received in real-time, latency can become an issue that is not present during training, when the data set can be pre-loaded.

In the process of defining the architecture of the DNN, the training module 630 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 630 defines the architecture of the DNN, the training module 630 inputs a training dataset into the DNN. The training dataset includes a plurality of training samples. An example of a training sample includes the source location of a feature in an audio sample and a ground-truth location of the feature. The training module 630 modifies the parameters inside the DNN (“internal parameters of the DNN”) to minimize the error between labels of the training features that are generated by the DNN and the ground-truth labels of the features. The internal parameters include weights of filters in the convolutional layers of the DNN. In some embodiments, the training module 630 uses a cost function to minimize the error.

The training module 630 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 630 finishes the predetermined number of epochs, the training module 630 may stop updating the parameters in the DNN. The DNN having the updated parameters is referred to as a trained DNN.

The validation module 640 verifies the accuracy of trained or compressed DNNs. In some embodiments, the validation module 640 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 640 may determine an accuracy score measuring the precision, recall, or a combination of precision and recall of the DNN. The validation module 640 may use the following metrics to determine the accuracy score: Precision=TP/(TP+FP) and Recall=TP/(TP+FN), where precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies precision and recall into a single measure.

The validation module 640 may compare the accuracy score with a threshold score. In an example where the validation module 640 determines that the accuracy score of the augmented model is less than the threshold score, the validation module 640 instructs the training module 630 to re-train the DNN. In one embodiment, the training module 630 may iteratively re-train the DNN until the occurrence of a stopping condition, such as the accuracy measurement indicating that the DNN may be sufficiently accurate, or a number of training rounds having taken place.

The inference module 650 applies the trained or validated DNN to perform tasks. The inference module 650 may run inference processes of a trained or validated DNN. In some examples, inference makes use of the forward pass to produce model-generated output for unlabeled real-world data. For instance, the inference module 650 may input real-world data into the DNN and receive an output of the DNN. The output of the DNN may provide a solution to the task for which the DNN is trained.

The inference module 650 may aggregate the outputs of the DNN to generate a final result of the inference process. In some embodiments, the inference module 650 may distribute the DNN to other systems, e.g., computing devices in communication with the deep learning system 600, for the other systems to apply the DNN to perform the tasks. The distribution of the DNN may be done through the interface module 610. The computing devices may be connected to the deep learning system 600 through a network.

The DNN may include a convolution module, which can perform platform self-noise suppression. In some examples, the convolution module can also perform additional real-time data processing, such as for speech enhancement, dynamic noise suppression, and/or self-noise silencing. The convolution module can include a time domain encoder, a frequency domain encoder, and a time domain decoder. In some examples, the time domain encoder is a convolutional time domain encoder, the frequency domain encoder is a convolutional frequency domain spectrum encoder, and the time domain decoder is a convolutional time domain decoder. In other embodiments, alternative configurations, different or additional components may be included in the convolution module. Further, functionality attributed to a component of the convolution module may be accomplished by a different component included in the convolution module, the deep learning system 600, or a different module or system.

The frequency encoder receives Short-Time Fourier transform (STFT) spectra. In various examples, the input data to the frequency encoder is frequency domain STFT spectra derived from input audio data. The input data includes input tensors which can each include multiple frames of data.

In various examples, a STFT is a Fourier-related transform used to determine the sinusoidal frequency and phase content of local sections of a signal as it changes over time. Generally, STFTs are computed by dividing a longer time signal into shorter segments of equal length and then computing the Fourier transform separately on each shorter segment. This results in the Fourier spectrum on each shorter segment. The changing spectra can be plotted as a function of time, for instance as a spectrogram. In some examples, the STFT is a discrete time STFT, such that the data to be transformed is broken up into tensors or frames (which usually overlap each other, to reduce artifacts at the boundary). Each tensor or frame is Fourier transformed, and the complex result is added to a matrix, which records magnitude and phase for each point in time and frequency. In some examples, an input tensor has a size of H×W×C, where H denotes the height of the input tensor (e.g., the number of rows in the input tensor or the number of data elements in a row), W denotes the width of the input tensor (e.g., the number of columns in the input tensor or the number of data elements in a row), and C denotes the depth of the input tensor (e.g., the number of input channels).

An inverse STFT can be generated by inverting the STFT. In various examples, the STFT is processed by the DNN, and it is then inverted at the decoder, or before being input to the decoder. By inverting the STFT, the encoded frequency domain signal from the frequency encoder can be recombined with the encoded time domain signal from the time encoder. One way of inverting the STFT is by using the overlap-add method, which also allows for modifications to the STFT complex spectrum. This makes for a versatile signal processing method, referred to as the overlap and add with modifications method. In various examples, the output from the decoder is an audio output signal representing the input signal for a selected audio source. In some examples, the output from the decoder includes multiple separated audio output signals, each representing the input signal for a respective input audio source.

The datastore 660 stores data received, generated, used, or otherwise associated with the deep learning system 600. For example, the datastore 660 stores the datasets used by the training module 630 and validation module 640. The datastore 660 may also store data such as the hyperparameters for training DNNs, internal parameters of trained DNNs (e.g., weights, etc.), data for sparsity acceleration (e.g., sparsity bitmap, etc.), and so on. In some embodiments, the datastore 660 is a component of the deep learning system 600. In other embodiments, the datastore 660 may be external to the deep learning system 600 and communicate with the deep learning system 600 through a network.

### Example Computing Device

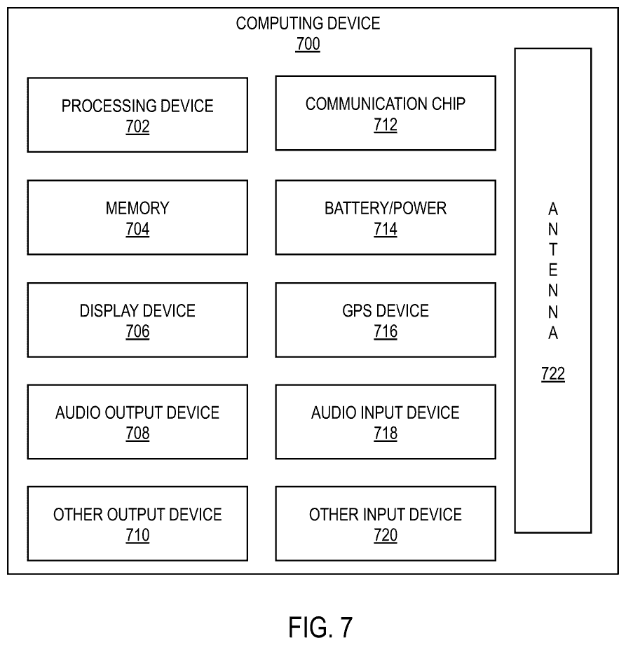

FIG. 7 is a block diagram of an example computing device 700, in accordance with various embodiments. In some embodiments, the computing device 700 may be used for at least part of the systems in FIGS. 1-6. A number of components are illustrated in FIG. 7 as included in the computing device 700, but any one or more of these components may be omitted or duplicated, as suitable for the application. In some embodiments, some or all of the components included in the computing device 700 may be attached to one or more motherboards. In some embodiments, some or all of these components are fabricated onto a single system on a chip (SoC) die. Additionally, in various embodiments, the computing device 700 may not include one or more of the components illustrated in FIG. 7, but the computing device 700 may include interface circuitry for coupling to the one or more components. For example, the computing device 700 may not include a display device 706, but may include display device interface circuitry (e.g., a connector and driver circuitry) to which a display device 706 may be coupled. In another set of examples, the computing device 700 may not include a video input device 718 or a video output device 708, but may include video input or output device interface circuitry (e.g., connectors and supporting circuitry) to which a video input device 718 or video output device 708 may be coupled.

The computing device 700 may include a processing device 702 (e.g., one or more processing devices). The processing device 702 processes electronic data from registers and/or memory to transform that electronic data into other electronic data that may be stored in registers and/or memory. The computing device 700 may include a memory 704, which may itself include one or more memory devices such as volatile memory (e.g., DRAM), nonvolatile memory (e.g., read-only memory (ROM)), high-bandwidth memory (HBM), flash memory, solid-state memory, and/or a hard drive. In some embodiments, the memory 704 may include memory that shares a die with the processing device 702. In some embodiments, the memory 704 includes one or more non-transitory computer-readable media storing instructions executable for loudspeaker leakage silencing, e.g., the methods discussed herein or some operations performed by the DNN system 600 in FIG. 6. The instructions stored in the one or more non-transitory computer-readable media may be executed by the processing device 702.

In some embodiments, the computing device 700 may include a communication chip 712 (e.g., one or more communication chips). For example, the communication chip 712 may be configured for managing wireless communications for the transfer of data to and from the computing device 700. The term “wireless” and its derivatives may be used to describe circuits, devices, systems, methods, techniques, communications channels, etc., that may communicate data using modulated electromagnetic radiation through a non-solid medium. The term does not imply that the associated devices do not contain any wires, although in some embodiments they might not.

The communication chip 712 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 712 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 712 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 712 may operate in accordance with code-division multiple access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 712 may operate in accordance with other wireless protocols in other embodiments. The computing device 700 may include an antenna 722 to facilitate wireless communications and/or to receive other wireless communications (such as AM or FM radio transmissions).

In some embodiments, the communication chip 712 may manage wired communications, such as electrical, optical, or any other suitable communication protocols (e.g., the Ethernet). As noted above, the communication chip 712 may include multiple communication chips. For instance, a first communication chip 712 may be dedicated to shorter-range wireless communications such as Wi-Fi or Bluetooth, and a second communication chip 712 may be dedicated to longer-range wireless communications such as global positioning system (GPS), EDGE, GPRS, CDMA, WiMAX, LTE, EV-DO, or others. In some embodiments, a first communication chip 712 may be dedicated to wireless communications, and a second communication chip 712 may be dedicated to wired communications.

The computing device 700 may include battery/power circuitry 714. The battery/power circuitry 714 may include one or more energy storage devices (e.g., batteries or capacitors) and/or circuitry for coupling components of the computing device 700 to an energy source separate from the computing device 700 (e.g., AC line power).

The computing device 700 may include a display device 706 (or corresponding interface circuitry, as discussed above). The display device 706 may include any visual indicators, such as a heads-up display, a computer monitor, a projector, a touchscreen display, a liquid crystal display (LCD), a light-emitting diode display, or a flat panel display, for example.

The computing device 700 may include a audio output device 708 (or corresponding interface circuitry, as discussed above). The audio output device 708 may include any device that generates an audible indicator, such as speakers, headsets, or earbuds, for example.

The computing device 700 may include a audio input device 718 (or corresponding interface circuitry, as discussed above). The audio input device 718 may include any device that generates a signal representative of a sound, such as microphones, microphone arrays, or digital instruments (e.g., instruments having a musical instrument digital interface (MIDI) output).

The computing device 700 may include a GPS device 716 (or corresponding interface circuitry, as discussed above). The GPS device 716 may be in communication with a satellite-based system and may receive a location of the computing device 700, as known in the art.

The computing device 700 may include another output device 710 (or corresponding interface circuitry, as discussed above). Examples of the other output device 710 may include a video codec, a printer, a wired or wireless transmitter for providing information to other devices, or an additional storage device.

The computing device 700 may include another input device 720 (or corresponding interface circuitry, as discussed above). Examples of the other input device 720 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 700 may have any desired form factor, such as a handheld or mobile computer system (e.g., a cell phone, a smartphone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 700 may be any other electronic device that processes data.

### SELECT EXAMPLES

Example 1 provides an apparatus, including a computer processor for executing computer program instructions; and a non-transitory computer-readable memory storing computer program instructions executable by the computer processor to perform operations including receiving an audio input signal from a microphone; receiving a loopback signal, where the loopback signal represents audio content played through one or more loudspeakers; processing the microphone signal and the loopback signal using a neural network model configured to generate an output mask; applying the output mask to the microphone signal to suppress non-linear echo components attributable to loudspeaker leakage, generating a processed microphone signal; and outputting the processed microphone signal.
Example 2 provides the apparatus of example 1, where the loopback signal includes at least two loopback channels, each loopback channel corresponding to a respective loudspeaker, and the neural network model processes both loopback channels.
Example 3 provides the apparatus of example 1 or 2, where the neural network model includes a light RNN-Mixer architecture configured to process interleaved features from the audio input signal and the loopback signal.
Example 4 provides the apparatus of any one of examples 1-3, where the output mask is generated such that the processed microphone signal retains a portion of linear echo for subsequent processing by a linear acoustic echo cancellation module.
Example 5 provides the apparatus of any one of examples 1-4, where the neural network is implemented in firmware prior to operating system audio processing object (APO) processing.
Example 6 provides the apparatus of any one of examples 1-5, where the neural network is implemented in firmware prior to a linear acoustic echo cancellation stage.
Example 7 provides the apparatus of any one of examples 1-6, where the neural network is implemented in firmware in a platform self-noise silencer, prior to a self-noise silencer stage.
Example 8 provides the apparatus of any one of examples 1-7, where applying the output mask suppresses a highest-energy portion of the non-linear echo components while leaving residual non-linear echo for subsequent post-filter processing.
Example 9 provides the apparatus of any one of examples 1-8, where the neural network model is trained using simulated audio signals including near-end and far-end sources, and where training includes augmentation steps including one or more of: sample rate simulation, silence simulation, delay variation, and dynamic range adjustment.
Example 10 provides a non-transitory computer-readable medium storing instructions executable to perform operations, the operations including receiving an audio input signal from a microphone; receiving a loopback signal, where the loopback signal represents audio content played through one or more loudspeakers; processing the microphone signal and the loopback signal using a neural network model configured to generate an output mask; applying the output mask to the microphone signal to suppress non-linear echo components attributable to loudspeaker leakage, generating a processed microphone signal; and outputting the processed microphone signal.
Example 11 provides the non-transitory computer-readable medium of example 10, where the loopback signal includes at least two loopback channels, each loopback channel corresponding to a respective loudspeaker, and the neural network model processes both loopback channels.
Example 12 provides the non-transitory computer-readable medium of example 10 or 11, where the neural network model includes a light RNN-Mixer architecture configured to process interleaved features from the audio input signal and the loopback signal.
Example 13 provides the non-transitory computer-readable medium of any one of examples 10-12, where the output mask is generated such that the processed microphone signal retains a portion of linear echo for subsequent processing by a linear acoustic echo cancellation module.
Example 14 provides the non-transitory computer-readable medium of any one of examples 10-13, where the neural network is implemented in firmware prior to operating system audio processing object (APO) processing.
Example 15 provides the non-transitory computer-readable medium of any one of examples 10-14, where the neural network is implemented in firmware prior to a linear acoustic echo cancellation stage.
Example 16 provides the non-transitory computer-readable medium of any one of examples 10-15, where the neural network is implemented in firmware in a platform self-noise silencer, prior to a self-noise silencer stage.
Example 17 provides the non-transitory computer-readable medium of any one of examples 10-16, where applying the output mask suppresses a highest-energy portion of the non-linear echo components while leaving residual non-linear echo for subsequent post-filter processing.
Example 18 provides the non-transitory computer-readable medium of any one of examples 10-17, where the neural network model is trained using simulated audio signals including near-end and far-end sources, and where training includes augmentation steps including one or more of: sample rate simulation, silence simulation, delay variation, and dynamic range adjustment.
Example 19 provides a computer-implemented method for audio enhancement, including receiving an audio input signal from a microphone; receiving a loopback signal, where the loopback signal represents audio content played through one or more loudspeakers; processing the microphone signal and the loopback signal using a neural network model configured to generate an attenuation mask; applying the attenuation mask to the microphone signal to suppress non-linear echo components attributable to loudspeaker leakage; and outputting a processed microphone signal with reduced loudspeaker leakage.
Example 20 provides the method of example 19, where the neural network model includes a light RNN-Mixer architecture configured to process interleaved features from the microphone signal and at least two loopback channels.
Example 21 provides the method of example 19 or 20, where the attenuation mask is generated such that the processed microphone signal retains a portion of linear echo for subsequent processing by a linear acoustic echo cancellation module.
Example 22 provides the method of any one of examples 19-21, where the neural network model is trained using simulated audio signals including near-end and far-end sources, and where training includes augmentation steps including one or more of: sample rate simulation, silence simulation, delay variation, and dynamic range adjustment.
Example 23 provides the method of any one of examples 19-22, where the neural network model is implemented in firmware prior to operating system audio processing object (APO) processing.
Example 24 provides the method of any one of examples 19-23, where the neural network model is implemented in firmware prior to a linear acoustic echo cancellation stage.
Example 25 provides the method of any one of examples 19-24, where applying the output mask includes suppressing a highest-energy portion of the non-linear echo components while leaving residual non-linear echo for subsequent post-filter processing.
Example 26 provides the method of any one of examples 19-25, wherein the neural network model is implemented in firmware in a platform self-noise silencer, prior to a self-noise silencer stage.
Example 27 provides an audio processing system including at least one microphone configured to capture audio signals; at least one loudspeaker configured to play audio content; a neural network module configured to receive a microphone signal and a loopback signal, and to output an attenuation mask for suppressing loudspeaker leakage in the microphone signal; and a processor configured to apply the attenuation mask to the microphone signal and output a processed signal with reduced loudspeaker leakage.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

What is claimed is:

1. An apparatus, comprising:
a computer processor for executing computer program instructions; and
a non-transitory computer-readable memory storing computer program instructions executable by the computer processor to perform operations comprising:
receiving an audio input signal from a microphone;
receiving a loopback signal, wherein the loopback signal represents audio content played through one or more loudspeakers;
processing the audio input signal and the loopback signal using a neural network model configured to generate an output mask;
applying the output mask to the audio input signal to suppress non-linear echo components attributable to loudspeaker leakage, generating a processed microphone signal; and
outputting the processed microphone signal.

2. The apparatus of claim 1, wherein the loopback signal includes at least two loopback channels, each loopback channel corresponding to a respective loudspeaker, and the neural network model processes both loopback channels.

3. The apparatus of claim 1, wherein the neural network model comprises a light RNN-Mixer architecture configured to process interleaved features from the audio input signal and the loopback signal.

4. The apparatus of claim 1, wherein the output mask is generated such that the processed microphone signal retains a portion of linear echo for subsequent processing by a linear acoustic echo cancellation module.

5. The apparatus of claim 1, wherein the neural network model is implemented in firmware prior to operating system audio processing object (APO) processing.

6. The apparatus of claim 1, wherein the neural network model is implemented in firmware prior to a linear acoustic echo cancellation stage.

7. The apparatus of claim 1, wherein the neural network model is implemented in firmware in a platform self-noise silencer, prior to a self-noise silencer stage.

8. The apparatus of claim 1, wherein applying the output mask suppresses a highest-energy portion of the non-linear echo components while leaving residual non-linear echo for subsequent post-filter processing.

9. The apparatus of claim 1, wherein the neural network model is trained using simulated audio signals comprising near-end and far-end sources, and wherein training includes augmentation steps including one or more of: sample rate simulation, silence simulation, delay variation, and dynamic range adjustment.

10. A non-transitory computer-readable medium storing instructions executable to perform operations, the operations comprising:
receiving an audio input signal from a microphone;
receiving a loopback signal, wherein the loopback signal represents audio content played through one or more loudspeakers;
processing the audio input signal and the loopback signal using a neural network model configured to generate an output mask;
applying the output mask to the audio input signal to suppress non-linear echo components attributable to loudspeaker leakage, generating a processed microphone signal; and
outputting the processed microphone signal.

11. The non-transitory computer-readable medium of claim 10, wherein the loopback signal includes at least two loopback channels, each loopback channel corresponding to a respective loudspeaker, and the neural network model processes both loopback channels.

12. The non-transitory computer-readable medium of claim 10, wherein the neural network model comprises a light RNN-Mixer architecture configured to process interleaved features from the audio input signal and the loopback signal.

13. The non-transitory computer-readable medium of claim 10, wherein the output mask is generated such that the processed microphone signal retains a portion of linear echo for subsequent processing by a linear acoustic echo cancellation module.

14. The non-transitory computer-readable medium of claim 10, wherein the neural network model is implemented in firmware prior to operating system audio processing object (APO) processing.

15. The non-transitory computer-readable medium of claim 10, wherein the neural network model is implemented in firmware prior to a linear acoustic echo cancellation stage.

16. The non-transitory computer-readable medium of claim 10, wherein the neural network model is implemented in firmware in a platform self-noise silencer, prior to a self-noise silencer stage.

17. The non-transitory computer-readable medium of claim 10, wherein applying the output mask suppresses a highest-energy portion of the non-linear echo components while leaving residual non-linear echo for subsequent post-filter processing.

18. The non-transitory computer-readable medium of claim 10, wherein the neural network model is trained using simulated audio signals comprising near-end and far-end sources, and wherein training includes augmentation steps including one or more of: sample rate simulation, silence simulation, delay variation, and dynamic range adjustment.

19. A computer-implemented method for audio enhancement, comprising:
receiving an audio input signal from a microphone;
receiving a loopback signal, wherein the loopback signal represents audio content played through one or more loudspeakers;
processing the audio input signal and the loopback signal using a neural network model configured to generate an attenuation mask;
applying the attenuation mask to the audio input signal to suppress non-linear echo components attributable to loudspeaker leakage; and
outputting a processed microphone signal with reduced loudspeaker leakage.

20. The method of claim 19, wherein the neural network model comprises a light RNN-Mixer architecture configured to process interleaved features from the microphone signal and at least two loopback channels.
